(19) United States
(12) Patent Application Publication
(10) Pub. No.: US 2011/0240162 A1
(43) Pub. Date: Oct. 6, 2011

(54) Vented end cap for medical tube

(76) Inventor: Rederick W. Zeyfang, Erie, PA (US)

(21) Appl. No.: 12/662,232

(22) Filed: Apr. 6, 2010

(51) Int. Cl. F16L 55/11; B65D 51/16

(52) U.S. Cl. 138/89.2; 220/203.11

(57) ABSTRACT

A flexible vented end cap for a medical gas tube is provided. The end cap comprises a closed end and an open end, and having a side wall having fit beads spaced about the circumference of an interior surface and extending longitudinally along the interior surface parallel to the longitudinal axis of the end cap, the end cap further including at least one radial fit bead extending across at least a portion of the interior bottom surface of the end cap to permit gas communication between the interior of the medical gas tube when inserted into the end cap and the environment external to the end cap, and the closed end having an outwardly flared circumferential portion to serve as a finger grip, and the exterior bottom surface of the end cap being concave in configuration.

### BACKGROUND OF THE PRESENT INVENTION

The present invention is directed to an end cap particularly adapted to be used to cap the ends of a medical gas tube.

Medical gas tubes need to be capped for various reasons, primarily to maintain dust free conditions.

Conventional end caps have been found to be unsatisfactory from the standpoint of being easily removed from the end of the gas tube. If the end cap is fit snuggly onto the gas tube, it is not only difficult to remove the cap from the end of the tube, but removal of the cap results in the formation of a vacuum effect within the gas line itself.

Also, if the gas line is not completely closed, pressure can build up within the line if the end cap is securely attached.

As a result, there is a need for providing an improved end cap for a medical gas line that addresses the above concerns.

### SUMMARY OF THE INVENTION

In accordance with the present invention, there is thus provided a flexible vented end cap for a medical gas tube,

the end cap comprising a closed end and an open end,

the end cap having a tubular side wall having multiple fit beads extending longitudinally along an interior surface thereof and spaced about the circumference of the interior surface, the fit beads configured to provide contact along their longitudinal extent with the external surface of a medical gas tube upon the tube being inserted into the end cap, with the fit beads preferably having a tapered end at the uppermost extent thereof, and

the end cap further including at least one radial fit bead extending across at least a portion of the interior bottom surface of the end cap to permit gas communication between the interior of said medical gas tube when inserted into the end cap and the environment external to the end cap, and

the closed end having an outwardly flared circumferential portion to serve as a finger grip, and the exterior bottom surface of the end cap being concave in configuration.

### BRIEF DESCRIPTION OF THE DRAWINGS

FIG. 1 is a bottom perspective view of the vented end cap of the present invention;

FIG. 2 is a top perspective view of the invention of FIG. 1;

FIG. 3 is a side view of the invention of FIG. 1, with all sides being identical;

FIG. 4 is a bottom view of the invention of FIG. 1;

FIG. 5 is a top view of the invention of FIG. 1;

FIG. 6 is a cross-sectional side view of the invention of FIG. 1; and

FIG. 7 is a cross-sectional side view of the invention of FIG. 1 rotated 90 degrees from the view of FIG. 6.

### DETAILED DESCRIPTION OF THE INVENTION

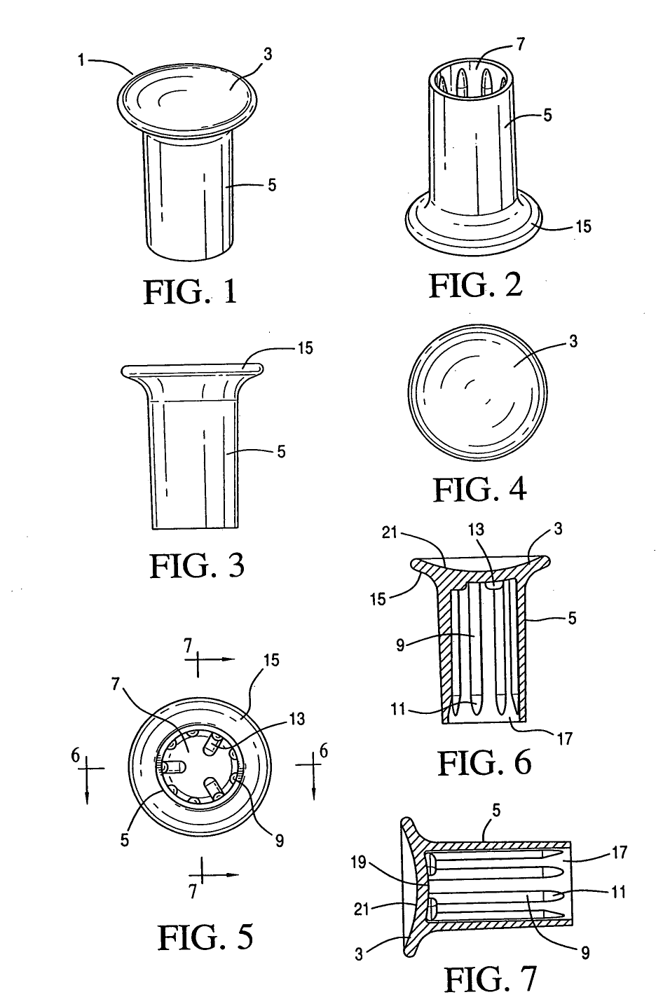

The invention will be described in connection with FIGS. 1-7.

The vented end cap 1 of the present invention comprises a closed end 3 and an open end 7. The open end 7 is defined by a circumferential tubular wall 5.

The interior surface of the wall 5 has multiple fit beads 9 extending inwardly from and longitudinally along the interior surface 17 of wall 5 and spaced about the circumference of the interior surface. The beads 9 are configured at their innermost point to provide contact with a tube (such as a medical gas tube) along the longitudinal surface of the beads. The external surface of a tube, upon being inserted into the end cap 1, abuts the innermost portion of the surface of the beads 9, and becomes snugly fit within the end cap body due to the combined action of the beads as they become compressed against the external surface of the tube.

The beads 9 extend longitudinally along at least a portion of the inner surface of the wall 5, beginning substantially adjacent the interior bottom surface 19 and terminating substantially adjacent the top of the wall. It is within the scope of the invention for the beads to terminate short of the end of the wall, such that the ends of the beads are spaced from the end of the wall. If spaced from the end of the wall, such spacing distance is not particularly critical to practice of the invention. However, for ease of insertion of the tube into the cap, it is preferred that the beads 9 extend substantially to the end of the wall. The end of the beads 9 preferably has a tapered configuration 11 to permit ease of insertion of the end of the tube into the end cap 1. The particular form of tapering is not critical to practice of the invention. The slope of the taper is also not critical, and will generally range from about 0.25 to 3 degrees. The beads extend along the interior surface 17 of the wall 5 along a line parallel to the longitudinal axis of the end cap.

It is not necessary for the beads to run from the bottom of the wall to the top of the wall adjacent the open end. Indeed, it is acceptable for the beads to extend along only a portion of the longitudinal extent of the wall in order for the objects of the present invention to be achieved.

The number of beads employed may vary. At a minimum, three fit beads would generally be employed, preferably equally spaced about the circumference of the interior surface 17 for the purpose of stability upon insertion of the tube. It is frequently desirable, however, to use a larger number of fit beads in order to minimize the spacing between the beads, while also ensuring a secure fit against the tube surface due to the greater number of contact points between the fit beads and the tube wall

Obviously, the number of fit beads employed will depend upon the size of the end cap, the size of the fit beads, and the amount of surface of the end cap desired to have fit beads. For instance, with a one inch end cap, 3-6 longitudinal fit beads may function well.

It is contemplated that the end caps of the present invention may be used with a variety of tubes of different sizes, as neither the size of the tube nor the size of the end cap is critical to practice of the present invention.

The fit beads may be of any configuration which provides the requisite contact with the tube wall. While rounded bead heads are shown in the Figures, beads having a more triangular configuration, or beads which have a more flattened upper surface, may be used with advantage.

The fit beads do not all need to be equally spaced about the circumference of the wall 5, nor do the fit beads have to be placed about the entire circumference. It is only necessary for sufficient fit beads to be at sufficient points about the circumference for the end cap to be snugly attached to the tube.

It is advantageous to provide bead segments 13 on the bottom interior surface 19 of the closed end 3 which bead segments extend inwardly along at least a portion of the interior bottom surface. The bead segments 13 serve as a seat for the end of the tube, and provide a space for air to exit the tube and pass upwardly in a space between the longitudinal fit beads along the wall of the end cap. This enables the end cap to be easily removed from the tube end, while avoiding the vacuum effect which would otherwise be the case. Such bead segments may be separate segments 13 as shown in FIG. 5. Alternatively, a single bead segment may extend across the entirety of the surface 19, or combinations of the two may be employed.

The closed end of the end cap also includes an outwardly flared portion 15 which may serve as a finger grip to assist removal of the end cap from engagement with the medical gas tube. The diameter of the closed end is thus greater than the diameter of the end cap at the open end. The end cap also includes a concave surface portion 21 which may also assist removal of the end cap from or with engagement with the medical tube as a convenient (ergonomic) surface for the thumb.

The end cap of the present invention may be produced by conventional injection molding techniques. The material employed for the end cap will typically be a thermoplastic or thermoset elastomer, for the reason that it is cost-effective, is flexible, has good tactile properties, and provides good resistance to most solvents and cleaning agents. Such materials also enable a wide range of fit over differing sizes of tubes. Such materials are well known to those skilled in the art and can readily be selected for use in the present invention.

What is claimed is:

1. A flexible vented end cap for a medical gas tube,
said end cap comprising a closed end and an open end,
said end cap having a tubular side wall having multiple fit beads extending longitudinally along at least a portion of an interior surface thereof and spaced about the circumference of said interior surface, said longitudinal fit beads configured to provide contact along their longitudinal extent with the external surface of a tube upon the end of the tube being inserted into said end cap,
said end cap further including at least one radial fit bead extending across at least a portion of the interior bottom surface of said end cap to permit gas communication between the interior of said medical gas tube when inserted into said end cap and the environment external to said end cap, and
said closed end having an outwardly flared circumferential portion to serve as a finger grip, and the exterior bottom surface of said end cap being concave in configuration.

2. The end cap of claim 1, wherein said longitudinal fit beads are evenly spaced about the entire circumference of said side wall.

3. The end cap of claim 1, wherein said fit beads have a curved surface.

4. The end cap of claim 1, wherein said longitudinal fit beads extend from said closed end to said open end of said end cap.

5. The end cap of claim 1, wherein said longitudinal fit beads terminate at a point spaced from said open end.

6. The end cap of claim 1, wherein said longitudinal fit beads terminate at a point spaced from said closed end.

7. The end cap of claim 1, wherein said longitudinal fit beads extend from a position spaced from said closed end to a position spaced from said open end.

8. The end cap of claim 1, wherein said fit beads have a tapered end at an uppermost end thereof closest to the open end of said end cap.

9. The end cap of claim 1, wherein multiple radial fit beads extend across at least a portion of said interior bottom surface.
